(19) United States
(12) Patent Application Publication
(10) Pub. No.: US 2014/0169135 A1
(43) Pub. Date: Jun. 19, 2014

(54) METHOD OF DETECTION OF LOW-FREQUENCY AND ULTRASONIC ACOUSTIC SIGNALS WITHIN A PREDETERMINED TIME FRAME

(71) Applicant: Evgeny Litovchenko, Nazareth Ellit (IL)

(72) Inventor: Evgeny Litovchenko, Nazareth Ellit (IL)

(73) Assignee: GSN ELECTRONIC COMPANY LTD., Nazareth Ellit (IL)

(21) Appl. No.: 14/235,835

(22) PCT Filed: Jul. 23, 2012
(86) PCT No.: PCT/IL2012/000285

§ 371 Date: Jan. 29, 2014

(30) Foreign Application Priority Data
Aug. 9, 2011 (IL) 214575

(51) Int. Cl. G08B 13/00; G01S 15/04

(52) U.S. Cl. CPC G08B 13/00; G01S 15/04
USPC 367/94

(57) ABSTRACT

A method for detecting an intrusion in a confined space is provided. The method includes the steps of detecting an ultrasonic acoustic signal with a Doppler shift and a low frequency acoustic signal, said signals being indicative of an intrusion, and generating an alarm if the ultrasonic acoustic signal with a Doppler shift and the low frequency acoustic signal were detected within an assigned timeframe.

### CROSS REFERENCE TO RELATED APPLICATIONS

This application claims the benefit of Israeli patent application No. 214575 filed on 9 Aug. 2011 which is incorporated herein by reference.

### FIELD OF THE INVENTION

The present invention relates to method and system for detecting an intrusion in a confined space and the implementation thereof.

### BACKGROUND OF THE INVENTION

It is known in the art to apply the Doppler principle in alarm systems for detection of intrusion. In devices of this type, radiation is emitted by a transmitter and is reflected by objects, including people. The reflected radiation is picked up by a receiver and evaluated. If the reflection results from an object at rest, the frequency of the received radiation coincides with the frequency of the transmitted radiation. If, however, the reflection results from an object which is moving with a velocity component in the direction of the transmitter and/or the receiver, or away from the transmitter or receiver, then a Doppler frequency shift occurs in the received radiation.

It is also known that an intrusion into a confined space, for example by breaking a window or a wall, generates a low frequency signal along with a Doppler frequency shift.

Known alarm systems utilize ultrasonic radiation in a frequency range of about 40 kHz, for example. However, ultrasonic devices have special disadvantages. One particular disadvantage is that the transmitted ultrasonic radiation is also influenced, for example, by moving air, for instance by attenuation fluctuations. Particularly in heated areas, however, air turbulence cannot be precluded.

In order to avoid false alarms, there is provided an alarm system in which one section that operates with low frequency radiation and another section that operates with ultrasonic waves. In this system it has been found that false alarms can be reduced or even totally avoided, if an alarm is given only when there is a coincidence, namely when an occurrence which is to be reported is detected by both sections; or even more preferably, if an alarm is given only when an occurrence which is to be reported is first detected by a section which operates with low frequency radiation and if said occurrence is detected by both sections.

### SUMMARY OF THE INVENTION

In accordance with a first aspect of the present invention, there is provided a method for determining an alarm condition, the method characterized by the steps of:

generating an ultrasonic acoustic signal and transmitting it into a confined space; and

detecting a LF acoustic signal and an ultrasonic acoustic signal with a Doppler shift, said signals being indicative of the intrusion; and

determining whether said LF acoustic signal and said ultrasonic acoustic signal with a Doppler shift were detected within an assigned timeframe; and

generating an alarm signal, if said LF acoustic signal and said ultrasonic acoustic signal with a Doppler shift were detected within an assigned timeframe.

In accordance with a second aspect of the present invention, there is provided a method for determining an alarm condition, the method characterized by the steps of:

generating an ultrasonic acoustic signal and transmitting it into a confined space; and

detecting a LF acoustic signal and an ultrasonic acoustic signal with a Doppler shift, said signals being indicative of the intrusion; and

determining whether said LF acoustic signal was detected before said ultrasonic acoustic signal with a Doppler shift; and

determining whether said LF acoustic signal and said ultrasonic acoustic signal with a Doppler shift were detected within an assigned timeframe; and

generating an alarm signal, if said LF acoustic signal was detected before said ultrasonic acoustic signal with a Doppler shift and said LF acoustic signal and said ultrasonic acoustic signal with a Doppler shift were detected within an assigned timeframe.

In accordance with a third aspect of the present invention, there is provided a detection system, the detection system is characterized by:

an ultrasonic transmitting unit arranged to generate and to transmit an ultrasonic acoustic signal into a confined space; and

an ultrasonic receiving unit arranged to receive and to detect an ultrasonic acoustic signal having a Doppler shift and to generate an electrical signal indicative of said Doppler shift; and a LF unit arranged to detect a LF acoustic signal and to generate an electrical signal indicative of said LF acoustic signal; and

a processing unit arranged to receive from said ultrasonic receiving unit an electrical signal indicative of the acoustic signal with a Doppler shift and from said LF unit an electrical signal indicative of the LF acoustic signal, said processing unit is configured to generate an alarm signal if said electrical signal indicative of the LF acoustic signal and said electrical signal indicative of the acoustic signal with a Doppler shift were received within an assigned time frame.

In accordance with a fourth aspect of the present invention, there is provided a detection system, the detection system is characterized by:

an ultrasonic transmitting unit arranged to generate and to transmit an ultrasonic acoustic signal into a confined space; and

an ultrasonic receiving unit arranged to receive and to detect an ultrasonic acoustic signal with a Doppler shift and to generate an electrical signal indicative of said Doppler shift; and

a LF unit arranged to detect a LF acoustic signal and to generate an electrical signal indicative of said LF acoustic signal; and

a processing unit arranged to receive from said ultrasonic receiving unit an electrical signal indicative of the acoustic signal with a Doppler shift and from said LF unit an electrical signal indicative of the LF acoustic signal, said processing unit is configured to generate an alarm signal if said electrical signal indicative of the LF acoustic signal was received before said electrical signal indicative of the acoustic signal with a Doppler shift and said electrical signal indicative of the LF acoustic signal and said electrical signal indicative of the acoustic signal with a Doppler shift were received within an assigned timeframe

Further aspects and advantageous features of the present invention are as described in the appended claims.

### BRIEF DESCRIPTION OF THE DRAWINGS

Exemplary embodiments of the present invention will now be described, by way of example only, with reference to the accompanying drawings, in which:

FIG. 1 illustrates a block diagram of a motion detection system in accordance with the preferred embodiment of the present invention;

FIG. 2 illustrates a flowchart of a motion detection operation in accordance with the preferred embodiment of the present invention;

FIG. 3 illustrates a flowchart of the motion detection operation in accordance with another preferred embodiment of the present invention.

### DETAILED DESCRIPTION OF THE INVENTION

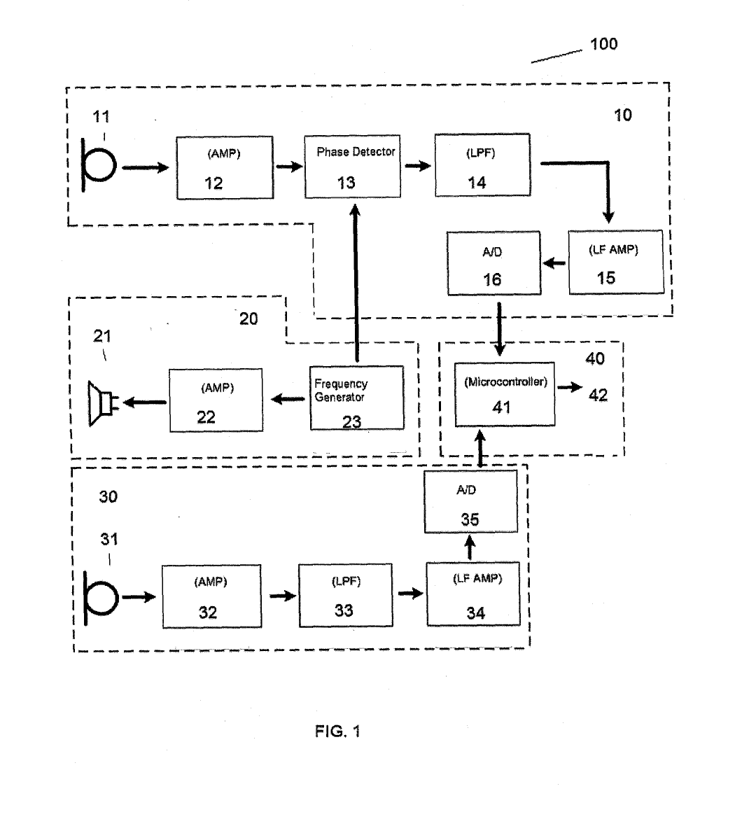

FIG. 1 illustrates a functional block diagram of a detection system 100, in accordance with a preferred embodiment of the present invention. The system 100 comprises an ultrasonic transmitting unit 20 which transmits an ultrasonic acoustic signal into the confined space that is to be monitored by the detection system 100, this space being known as the protected space. The ultrasonic transmitting unit 20 of the preferred embodiment of the present invention comprises a frequency generator 23 (which may be a quartz generator) that provides an ultrasonic signal, preferably of 40 kHz, for an ultrasonic acoustic transmitter 21, the signal first being amplified by an amplifier 22.

The ultrasonic acoustic signal is reflected by objects within the protected space and its frequency is shifted by objects within the space that are in motion, i.e. intruders (Doppler shift). An ultrasonic receiving unit 10 detects any reflected and frequency shifted ultrasonic acoustic signals and generates an electrical signal which is indicative of the Doppler shift of these signals. The ultrasonic receiving unit 10 of the preferred embodiment of the present invention comprises an ultrasonic acoustic receiver 11 that receives a reflected and frequency shifted ultrasonic acoustic signal. The output of said receiver 11 is then further amplified by a selective amplifier 12. The amplified signal is then inputted into a phase detector 13, that also receives an input from the frequency generator 23. The subtracted signal from the phase detector 13 is further filtered by a low pass filter 14, preferably with a cut-off frequency of 1 kHz. The filtered signal is actually a signal having the Doppler Effect frequency. This signal is then amplified by a low frequency amplifier 15 and digitized by means of an AID converter 16 prior to being further processed by a processing unit 40.

The system 100 also comprises a low frequency (LF) unit 30 which detects low frequency acoustic signals generated by intruders, for example low frequency acoustic signals generated by breaking a window or a wall, and generates an electrical signal that is further processed by the processing unit 40. The LF unit 30 of the preferred embodiment of the present invention comprises a low frequency acoustic microphone 31 that receives low frequency acoustic signals, indicative of an intrusion into the protected space. The output of said LF microphone 31 is then amplified by an amplifier 32 and further filtered by a low pass filter 33, preferably having a cut-off frequency of 100 Hz. This signal is then amplified by a low frequency amplifier 34 and digitized by means of an A/D converter 35 prior to being further processed by the processing unit 40.

The processing unit 40 comprises a programmable microcontroller 41 which is connected to the A/D converter 16 of said ultrasonic receiving unit 10 and to the A/D converter 35 of said LF unit 30. Said processing unit 40 receives input signals from the ultrasonic receiving unit 10 and from the low frequency unit 30. The microcontroller 41 is configured according to the preferred embodiment of the present invention to determine whether said input signals were detected within an assigned time period and to generate an alarm signal 42, only if both of said received input signals were received within an assigned time period, wherein said time period is preferably less than 2 seconds, and more preferably is less than 1 second, and even more preferably is less than 0.5 second.

According to another preferred embodiment of the present invention, the microcontroller 41 is configured to determine if an input signal from the low frequency unit 30 was received before an input signal from the ultrasonic receiving unit 10 and to determine if both of said received input signals were detected within an assigned time period, and to generate the alarm signal 42 only if the input signal from said low frequency unit 30 was received before the input signal from said ultrasonic receiving unit 10 and both of said received input signals were detected within an assigned time period, wherein said time period is preferably less than 2 seconds, and more preferably is less than 1 second, and even more preferably is less than 0.5 second.

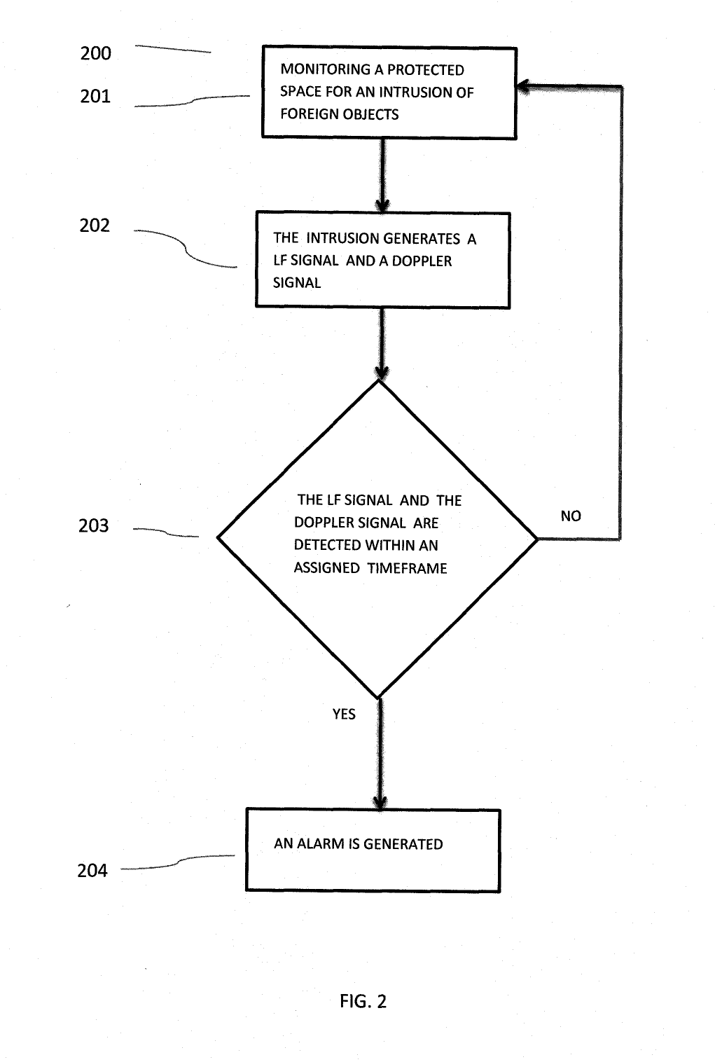

Referring now to FIG. 2, a flowchart 200 illustrates intrusion detection in accordance with the preferred embodiment of the present invention. The flowchart 200 commences with a protected space being monitored for an intrusion of foreign objects, as shown in step 201. In the case of the intrusion, a LF acoustic signal and a Doppler signal (i.e. an ultrasonic acoustic signal with a Doppler shift) are generated (step 202) and if both of them are detected within an assigned timeframe (step 203), the alarm is generated (step 204).

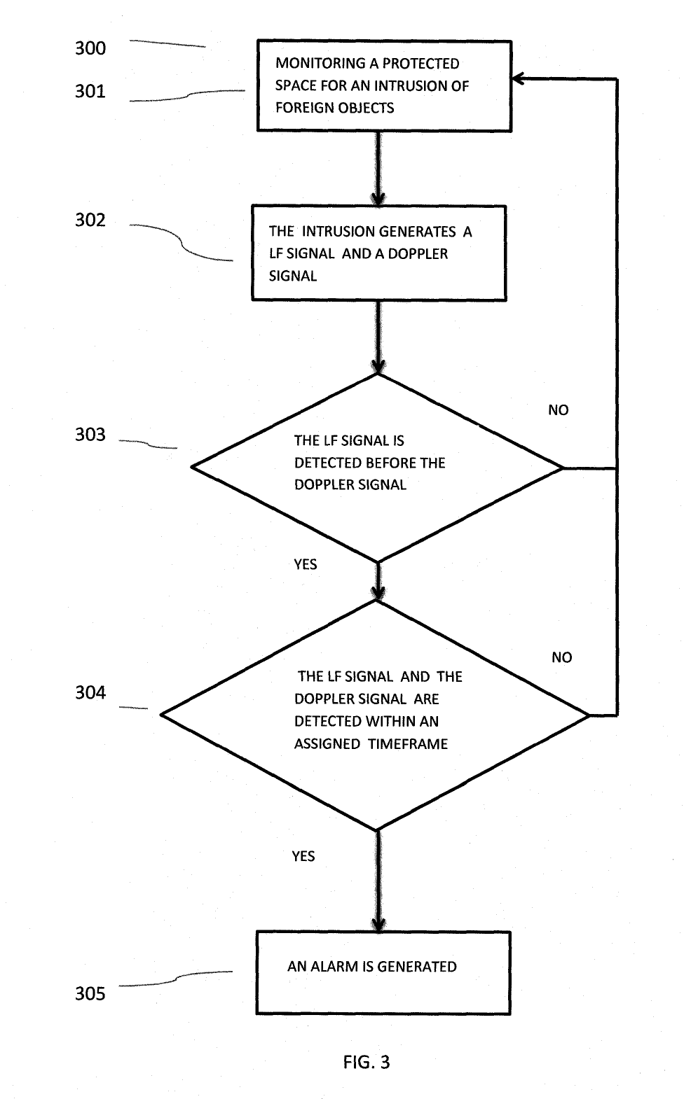

Referring now to FIG. 3, a flowchart 300 illustrates intrusion detection in accordance with another preferred embodiment of the present invention. The flowchart 300 commences with a protected space being monitored for an intrusion of foreign objects, as shown in step 301. In the case of the intrusion, a LF acoustic signal and a Doppler signal are generated (step 302) and if the LF signal is detected before the Doppler signal (step 303) and also if the LF and the Doppler signals are detected within an assigned timeframe (step 304), the alarm is generated (step 305).

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1-11. (canceled)

12. A method for determining an alarm condition for a confined space, wherein the method comprises the steps of:
generating an ultrasonic acoustic signal and transmitting it into a confined space; and
detecting a LF acoustic signal and an ultrasonic acoustic signal with a Doppler shift, said signals being indicative of the intrusion; and
determining whether said LF acoustic signal and said ultrasonic acoustic signal with a Doppler shift were detected within an assigned timeframe; and
generating an alarm signal, if said LF acoustic signal and said ultrasonic acoustic signal with a Doppler shift were detected within an assigned timeframe.

13. A method for determining an alarm condition for a confined space, wherein the method comprises the steps of:
generating an ultrasonic acoustic signal and transmitting it into a confined space; and
detecting a LF acoustic signal and an ultrasonic acoustic signal with a Doppler shift, said signals being indicative of the intrusion; and
determining whether said LF acoustic signal was detected before said ultrasonic acoustic signal with a Doppler shift; and
determining whether said LF acoustic signal and said ultrasonic acoustic signal with a Doppler shift were detected within an assigned timeframe; and
generating an alarm signal, if said LF acoustic signal was detected before said ultrasonic acoustic signal with a Doppler shift, and said LF acoustic signal and said ultrasonic acoustic signal with a Doppler shift were detected within an assigned timeframe.

14. The method of claim 12, wherein the assigned timeframe is less than 2 seconds.

15. The method of claim 12, wherein the assigned timeframe is less than 1 second.

16. The method of claim 12, wherein the assigned timeframe is less than 0.5 second.

17. A detection system for determining an alarm condition for a confined space, wherein the system comprises:
an ultrasonic transmitting unit arranged to generate and to transmit an ultrasonic acoustic signal into a confined space; and
an ultrasonic receiving unit arranged to receive and to detect an ultrasonic acoustic signal with a Doppler shift and to generate an electrical signal indicative of said Doppler shift; and
a LF unit arranged to detect a LF acoustic signal and to generate an electrical signal indicative of said LF acoustic signal; and
a processing unit arranged to receive from said ultrasonic receiving unit an electrical signal indicative of the acoustic signal with a Doppler shift and from said LF unit an electrical signal indicative of the LF acoustic signal, said processing unit is configured to generate an alarm signal if said electrical signal indicative of the LF acoustic signal was received before said electrical signal indicative of the acoustic signal with a Doppler shift, and said electrical signal indicative of the LF acoustic signal and said electrical signal indicative of the acoustic signal with a Doppler shift were received within an assigned timeframe.

18. The detection system according to claim 17, wherein the assigned timeframe is less than 2 seconds.

19. The detection system according to claim 17, wherein the assigned timeframe is less than 1 second.

20. The detection system according to claim 17, wherein the assigned timeframe is less than 0.5 second.

21. The detection system according to claim 17, wherein said ultrasonic transmitting unit comprises an ultrasonic frequency generator connected to an amplifier and via said amplifier to an ultrasonic acoustic transmitter; and in that said ultrasonic receiving unit comprises an ultrasonic acoustic receiver, a selective amplifier connected to said ultrasonic acoustic receiver, a phase detector connected to said selective amplifier and to an ultrasonic frequency generator, a low pass filter connected to said phase detector, a LF amplifier connected to said low pass filter and an ND converter connected to said LF amplifier; and in that said LF unit comprises a LF microphone, an amplifier connected to said LF microphone, a low pass filter connected to said amplifier, a LF amplifier connected to said low pass filter and an ND converter connected to said LF amplifier; and in that said processing unit comprises a programmable microcontroller connected to the A/D converter of said ultrasonic receiving unit and to the A/D converter of said LF unit.
